(19) United States
(12) Patent Application Publication
(10) Pub. No.: US 2025/0162276 A1
(43) Pub. Date: May 22, 2025

(54) THERMALLY BONDED COMPOSITE MATERIALS

(71) Applicant: DelStar Technologies, Inc., Alpharetta, GA (US)

(72) Inventors: Yasar Kiyak, Alpharetta, GA (US); Andrew G. Platt, Middletown, DE (US); Chris Hakanson, Alpharetta, GA (US)

(21) Appl. No.: 18/943,003

(22) Filed: Nov. 11, 2024

Related U.S. Application Data
(60) Provisional application No. 63/601,904, filed on Nov. 22, 2023.

(51) Int. Cl. B32B 5/26; B32B 5/02; B32B 7/027; D04G 1/00; D04H 1/4291; D04H 1/435; D04H 1/4382

(52) U.S. Cl. CPC B32B 5/273; B32B 5/022; B32B 5/028; B32B 7/027; D04G 1/00; D04H 1/4291; D04H 1/435; D04H 1/43828; D04H 1/43835; B32B 2250/20; B32B 2262/0253; B32B 2262/124; B32B 2307/30; D10B 2321/021

(57) ABSTRACT

The present disclosure provides composite materials comprising nettings, mattings or meshes thermally bonded to outer layers of nonwoven fibers that may be configured for use in a variety of applications and products. A composite material comprises a first layer of netting comprising intersecting strands and a second layer in contact with the first layer. The second layer comprises first and second fiber components. The first fiber components have a melting point at least 20 degrees higher than the melting point of the netting. The second fiber components have a melting point within 20 degrees Celsius of the fibers in the netting layer. This allows the second fiber components to thermally bond with the netting at contact points upon the application of heat and pressure. The first fiber components do not substantially thermally bond to the netting and thus form an outer layer, such as a sock, that protects the netting layer.

### CROSS-REFERENCE TO RELATED APPLICATIONS

This application claims the benefit of U.S. Provisional Patent Application Ser. No. 63/601,904 filed Nov. 22, 2023, the complete disclosure of which is incorporated herein by reference in its entirety for all purposes.

### TECHNICAL FIELD

This description generally relates to compositive materials that include reticular structures, such as nettings, mattings or meshes, and methods for manufacturing such materials.

### BACKGROUND

Polymeric netting materials are used for a wide variety of applications, such as drainage, insulation, ground vibration damping, noise control and ventilation in buildings, resin infusion media, foam flow media and resin transfer media for vacuum infusion and structural injection molding, filter media for industrial filtration and wastewater treatment, erosion control, soil consolidation, landfill stabilization, reinforcement, separation, containment, protection and the like. One particular application of polymeric netting materials is resin infusion flow media for creating laminated parts or high performance composite components. The netting creates fast moving channels of resin that permit a wider dispersion path and more uniform infusions.

Polymeric nettings typically comprise flexible mattings produced from polymer monofilaments, such as polyamide, nylon, polyester, polypropylene and the like. These monofilaments are thermally bonded together where they cross to form a flexible, compression resistant matrix with a substantial amount of void space. The tight, low profile crisscross pattern of the netting distributes a controlled, predictable flow of resin throughout the laminate.

In some applications, one or more outer layer(s) of continuous multicomponent nonwoven filaments are thermally bonded to the polymeric netting. The nonwoven filaments may be formed as a covering or sock that encases the netting to provide an outer protective layer for the netting and to improve its overall performance.

### SUMMARY

Composite materials and methods for manufacturing the composite materials are provided. The composite materials include nettings, mattings or meshes thermally bonded to one or more outer layer(s) of nonwoven fibers and may be configured for use in a variety of applications and products, including but not limited to, filter jackets, capillary break layers, shock pads, turf protection layers, soil consolidation, drainage, insulation, ground vibration damping, noise control and ventilation in buildings, resin infusion media, foam flow media and resin transfer media for vacuum infusion and structural injection molding, filter media for industrial filtration and waste water treatment, erosion control, soil consolidation, landfill stabilization and gas venting, reinforcement, separation, containment, protection, agricultural applications and the like.

In one aspect, a composite material comprises a first layer of netting comprising an array of intersecting strands or monofilaments and a second layer in contact with the first layer. The second layer comprises fibers having a melting point that is at least about 20 degrees Celsius higher than the melting point of the strands within the netting.

In various embodiments, the second layer comprises first and second fiber components. The first fiber components have a melting point at least about 20 degrees Celsius higher than the melting point of the netting. The second fiber components have a melting point within about 20 degrees Celsius of the strands in the netting layer. This allows the second fiber components to thermally bond with the netting strands at contact points upon the application of heat and pressure. The first fiber components do not substantially thermally bond to the netting and thus form an outer layer that protects the netting layer and improves the overall performance of the composite material.

The fibers in the second layer may comprise biocomponent fibers that include two or more different fibers bonded to each other. The bicomponent fiber may comprise any suitable shape, such as core/sheath with a concentric core, core/sheath with an eccentric core, side by side with a solid or a hollow core, side by side with a concentric or an eccentric hollow core, segmented pie with a solid or a hollow core, striped fibers, conductive fibers, island by the sea, mixed fibers, or combinations thereof.

In an exemplary embodiment, the biocomponent fibers comprise a core/sheath fiber having a concentric core. The core of the bicomponent fibers comprise a material with a melting point at least about 20 degrees Celsius higher than the melting point of the fibers in the netting. The sheath comprises a material with a melting point within about 20 degrees Celsius of the melting point of the strands in the netting. Thus, the sheath thermally bonds with the netting while the core does not thermally bond with the netting, which allows the core fibers to provide an outer protective layer for the netting.

Suitable materials for the netting strands include, but are not limited to, high density polyethylene (HDPE), low density PE, polyethylene, polypropylene (isotactic PP), metallocene PP, polylactic acid (PLA). thermoplastic polymers, nylon, polybutylene terephthalate (PBT), thermoplastic elastomer (TBE), polyphenylene sulfide (PPS), polyvinylidene fluoride (PVDF) and combinations thereof. In an exemplary embodiment, the netting comprises HDPE, PP and combinations thereof.

The fibers in the second layer preferably comprise nonwoven fibers. Suitable nonwoven materials include, but are not limited to, fibers, layers or webs that are meltblown, spunbond or spunlace, heat-bonded, bonded carded, air-laid, wet-laid, co-formed, needlepunched, stitched, hydraulically entangled or the like. In an exemplary embodiment, the fibers are carded and then air-through bonded.

Suitable materials for the first fiber component in the second layer include, but are not limited to, PET, PLA, Ziegler-Netta PP and combinations thereof. Suitable materials for the second fiber component in the second layer include, but are not limited to, HDPE, metallocene PP, CoPET, PP, PLA and combinations thereof. In an exemplary embodiment, the first fiber component comprises PET and the second fiber component comprises HDPE.

In one embodiment, the netting comprises HDPE and the core/sheath bicomponent fiber comprises PET/HDPE. In another embodiment, the netting comprises metallocene PP and the core/sheath bicomponent fiber comprises Ziegler-Netta PP/metallocene PP. In another embodiment, the netting comprises HDPE and the core/sheath bicomponent fiber comprises PET/CoPET. In another embodiment, the netting comprises PP and the core/sheath bicomponent fiber comprises PET/PP. In another embodiment, the netting comprises PLA and the core/sheath bicomponent fiber comprises PLA/PLA.

In various embodiments, the fiber layers may be disposed on one side, or both sides, of the netting. In certain embodiments, the fiber layers may partially or completely surround the netting to form an outer protective cover or sock around the netting.

In various embodiments, the composite material may comprise multiple layers of netting and/or multiple layers of fibers. In one such embodiment, the composite material comprises a third layer of fibers overlying the second layer of fibers. The third layer of fibers have at least a first component with a melting point higher than the melting point of the netting material, preferably at least 20 degrees Celsius higher. The third layer may further comprise a second fiber component having a melting point within 20 degrees Celsius of the netting material

In certain embodiments, the second and third layers comprise the same material. In other embodiments, the second and third layers comprises different materials. In these embodiments, the second layer functions to bind the netting with both layers of fibers and the third layer functions as a performance material. In some embodiments, the third layer comprises fibers having a higher melting than the fibers of the second layer and/or the netting to provide thermal stability to the composite material. In an exemplary embodiment, the melting point of the fibers in the third layer is 30% greater than the melting point of the fibers in the second layer and/or the strands in the netting.

In various embodiments, the composite material may include multiple layers of netting. The two layers of netting may be disposed on opposite sides of the fiber layers, or they may be disposed between the fiber layers.

In another aspect, a product is provided comprising the composite material(s) described above. The product may comprise, for example, a resin infusion media, a foam flow media, a resin transfer media, an acoustic insulation material, a drainage mat, a capillary break layer, an erosion control device, a ground vibration dampener, a landfill stabilization device, a filter media, a gas venting device or a turf or soil protection layer.

In another aspect, a resin infusion media is provided comprising the composite material(s) described above. The resin infusion media may be configured to facilitate a controlled, predictable flow of resin in resin infusion projects and may, for example, be used at the surface, or as a separation layer between layers of reinforcement of a composite material.

In another aspect, a composite material comprises a layer of netting having a first melting point, a plurality of first fibers having a second melting point and a plurality of second fibers having a third melting point. The difference between the first and third melting points is less than 20 degrees Celsius and the second melting point is at least 20 degrees higher than the first melting point.

In various embodiments, the second fibers are thermally bonded to the netting and the first fibers are not substantially thermally bonded to the netting.

In various embodiments, the first and second fibers are formed from biocomponent fibers. In one such embodiment, the biocomponent fibers comprise a core and a sheath. The first fibers comprise the core and the second fibers comprise the sheath.

In another aspect, a method of manufacturing a composite material comprises providing a netting and first and second fibers having first and second melting points, and heating the first and second fibers and the netting to a temperature at or above the second melting point and below the first melting point to thermally bond the second fibers to the netting.

In various embodiments, the netting has a third melting point at least 20 degrees less than the first melting point and substantially equal to the second melting point.

In various embodiments, the netting and the first fibers are thermally bonded by lamination, calendaring, air through bonding, ultrasonic bonding or chemical bonding. In an exemplary embodiment, the netting and first fibers are laminated and calendared.

In various embodiments, the method further includes forming bicomponent fibers comprising the first and second fibers. The biocomponent fibers may be formed by any suitable method, including meltspinning, meltblown, spunbond or spunlace, heat-bonded, air-though bonded carded, air-laid, wet-laid, co-formed, needlepunched, stitched, hydraulically entangled or the like. In an exemplary embodiment, the bicomponent fibers are carded and then air through bonded.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 is a cross-sectional view of a composite material comprising a first layer of nonwoven material and a layer of netting;

FIG. 2 illustrates a process for manufacturing a composite material;

FIG. 3 is a cross-sectional view of a composite material comprising first and second layers of nonwoven material and a layer of netting;

FIG. 4 is a cross-sectional view of an alternative composite material comprising first and second layers of nonwoven material and a layer of netting;

FIG. 5 is a cross-sectional view of a composite material comprising four layers of nonwoven material and a layer of netting;

FIG. 6 is a cross-sectional view of an alternative composite material comprising four layers of nonwoven material and a layer of netting;

FIG. 7 is a cross-sectional view of an alternative composite material comprising four layers of nonwoven material and a layer of netting;

FIG. 8 is a cross-sectional view of an alternative composite material comprising two layers of netting and two layers of nonwoven material; and

FIG. 9 is a perspective view of a composite material comprising a netting and a nonwoven outer layer.

### DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Composite materials and nettings, meshes or mattings are provided that are configured for use in a variety of applications, such as filter jackets, capillary break layers, shock pads, turf protection layers, soil consolidation, drainage, insulation, ground vibration damping, noise control and ventilation in buildings, resin infusion media, foam flow media and resin transfer media for vacuum infusion and structural injection molding, filter media for industrial filtration and waste water treatment, erosion control, soil consolidation, landfill stabilization and gas venting, reinforcement, separation, containment, protection, agricultural applications and the like. Methods of manufacturing the composite materials and nettings are also provided.

The composite materials may also be used for packaging netting, such as for onion and turkey bags; agricultural netting, such as for turf netting, turf wrap, hay bale, etc. and, netting for industrial, filtration and home furnishings applications. Additionally, the composite materials may be adapted for use in composite fabrics for disposable diapers, incontinent briefs, training pants, bandages, dressings, diaper holders and liners and feminine hygiene garments, medical gowns, medical drapes, mattress pads, blankets, sheets, clothing, consumer wipes and other like products, such as building and construction composites.

Referring now to FIG. 1, a composite material 100 comprises a first layer of netting 110 comprising an array of intersecting strands or monofilaments and a second layer 120 in contact with netting 110. Second layer 120 comprises at least one set of fibers having a melting point that is higher than the melting point of the strands within netting 110. In various embodiments, the melting point of the fibers in second layer 120 is at least 20 degrees Celsius higher than the melting point of netting 110.

In embodiments, the reticular structure comprises an extruded polymeric netting produced from high-temperature thermoplastic monofilaments or strands. The monofilaments or strands may be thermally bonded together where they cross to form a flexible, compression resistant matrix with a substantial amount of void space. The tight, low profile crisscross pattern of the netting distributes a controlled, predictable flow of fluid through the filter media.

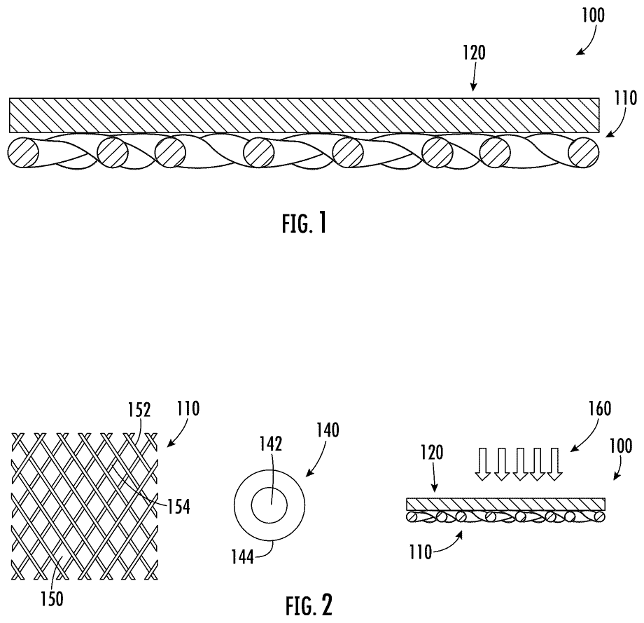

Second layer 120 may comprise first and second fiber components. The first fiber components have a melting point at least 20 degrees Celsius higher than the melting point of the netting. The second fiber components have a melting point within 20 degrees Celsius of the strands in the netting layer. In some embodiments, the melting point of the second fiber components is substantially equal to the melting point of the netting. This allows the second fiber components in second layer 120 to thermally bond with netting 110 at contact points upon the application of heat and pressure 160 (see FIG. 2). The first fiber components of second layer 120 generally do not bond with netting 110, thereby forming an outer layer that protects netting 110.

Suitable materials for netting 110 include, but are not limited to, high density polyethylene (HDPE), low density polyethylene, polyethylene, polypropylene (PP), metallocene PP, polylactic acid (PLA). thermoplastic polymers, nylon, polybutylene terephthalate (PBT), thermoplastic elastomers (TBE), polyphenylene sulfide (PPS), polyvinylidene fluoride (PVDF) and combinations thereof. In an exemplary embodiment, the netting comprises HDPE, PP and combinations thereof.

Netting 110 may be formed from any suitable method such as extrusion, co-extrusion, bi-component, and elastomeric nettings. In an exemplary embodiment, the netting is formed from a mono-extrusion process. Generally, suitable methods for making the extruded netting includes extruding a polymeric blend composition through dies with reciprocating or rotating parts to form the netting configuration. This creates cross machine direction strands that cross the machine direction strands, which flow continuously. After the extrusion, the netting is then typically stretched in the machine direction using a differential between two sets of nip rollers.

The netting may include additional materials for color, UV stabilizers, antistatics, flame retardant additives, antimicrobial additives, such as silver, triclosan, heavy metals and the like.

Netting 110 comprises a plurality of apertures or holes 150 (see FIG. 2). The apertures 150 may comprise pores or perforations. The apertures may have any suitable shape, such as diamond, circular, hexagonal, square, rectangular or combinations thereof. In an exemplary embodiment, the apertures 150 have a substantially diamond shape. The apertures 150 may have a size of at least about 50 microns, or at least about 150 microns, preferably at least about 250 microns. In an exemplary embodiment, the apertures formed by the strands are symmetrical although it will be recognized that the apertures may be non-symmetrical in certain embodiments.

Apertures 150 may be formed from a first series of strands 152 extending in one direction and a second series of strands 154 extending in a generally crosswise or transverse direction. The first and second sets of strands 152, 154 are extruded polymeric elongate members which cross and intersect during extrusion to form the net-like structure. The strands could also be formed of extruded strands that are knitted together rather than crossed during extrusion. In some embodiments, the strands are made of the same material. In other embodiments, the first set of strands 152 are made of a different material than the second set of strands 154. For example, the netting may include 10 to 90 wt. % of the material of the first set of strands and 10 to 90 wt. % of the material of the second set of strands. In still other embodiments, the netting may include 45 to 55 wt. % of the material of strands 12 and 45 to 55 wt. % of the material of strands 14.

The thickness of the strands 152, 154 is preferably about 0.006 inches to about 0.400 inches. The strand density is preferably less than about 100 strands per inch, or less than about 50 strands per inch, or less than about 44 strands per inch. The strands may be formed at an angle of about 10 to about 90 degrees, or about 70 to about 80 degrees, or about 75 degrees. The netting may have a strand density of about 20 strands per inch to about 100 strands per inch, or about 25 strands per inch to about 35 strands per inch.

In an exemplary embodiment, the apertures formed by the strands are symmetrical although it will be recognized that the apertures may be non-symmetrical in certain embodiments. In certain embodiments, both sets of strands may extend in a direction at an angle to the MD. In other embodiments, one of the sets of strands may extend in a direction substantially parallel to the MD. In some embodiments, one of the sets of strands extends substantially parallel to the MD and the other set of strands extends substantially parallel to the CD. The strands may have the same number and thickness or they may have a different number and/or thickness.

The fibers in second layer 120 are preferably nonwoven fibers. The nonwoven fibers may comprise a structure of individual fibers or threads that are interlaid, interlocked, or bonded together. Nonwoven fabrics may include sheets or web structures bonded together by entangling fiber or filaments (and by perforating films) mechanically, thermally, or chemically. They may be substantially flat, porous sheets that are made directly from separate fibers or molten plastic or plastic film. Examples of suitable nonwoven materials include, but are not limited to, fibers, layers or webs that are meltblown, spunbond or spunlace, heat-bonded, bonded carded, air-laid, wet-laid, co-formed, needlepunched, stitched, hydraulically entangled or the like. In an exemplary embodiment, the nonwoven fibers are card and then air-through bonded.

The fibers in second layer 120 may comprise biocomponent fibers that include two or more different fibers bonded to each other. The bicomponent fibers may comprise any suitable shape, such as core/sheath with a concentric core, core/sheath with an eccentric core, side by side with a solid or a hollow core, side by side with a concentric or an eccentric hollow core, segmented pie with a solid or a hollow core, striped fibers, conductive fibers, island by the sea, mixed fibers, or combinations thereof.

In an exemplary embodiment (shown in FIG. 2), the biocomponent fibers comprises a core/sheath fiber 140 having a concentric core 142. The core 142 of bicomponent fiber 140 comprises a material with a melting point at least 20 degrees Celsius higher than the melting point of the strands in the netting. Sheath 144 comprises a material with a melting point less than 20 degrees different than the melting point of the strands in the netting. Thus, upon application of heat 160 to netting 110 and second layer 120 at a temperature near the melting point of netting 110, but less than the melting point of core 142, sheath 144 thermally bonds with the netting 110 while core 142 does not thermally bond with netting 110, which allows the sheath fibers 144 to remain as an outer protective layer for the netting 110.

Suitable materials for core 142 include, but are not limited to, PET, PLA, Ziegler-Netta PP and combinations thereof. Suitable materials for sheath 144 include, but are not limited to, HDPE, metallocene PP, CoPET, PP, PLA and combinations thereof.

In one embodiment, the netting comprises HDPE and the core/sheath bicomponent fiber comprises PET/HDPE. In another embodiment, the netting comprises metallocene PP and the core/sheath bicomponent fiber comprises Ziegler-Netta PP/metallocene PP. In another embodiment, the netting comprises HDPE and the core/sheath bicomponent fiber comprises PET/CoPET. In another embodiment, the netting comprises PP and the core/sheath bicomponent fiber comprises PET/PP. In another embodiment, the netting comprises PLA and the core/sheath bicomponent fiber comprises PLA/PLA. The PLA in the core comprises a PLA with a higher melting point than the PLA in the sheath and the netting.

In various embodiments, second layer 120 may comprise multiple sets of fibers. For example, in one embodiment, second layer 120 comprises biocomponent fibers as described above and another set of fibers that may be bicomponent fibers or monocomponent fibers. In an exemplary embodiment, second layer 120 comprises about 50% to about 95% bicomponent fibers, or about 60% to about 90%, or at least about 70%. Second layer 120 may further comprise about 5% to about 50% monocomponent fibers, or about 10% to about 40% or 30% or less.

The monocomponent fibers may comprise any suitable fiber material such as PET, PLA, Ziegler-Netta PP, HDPE, metallocene PP, CoPET, and combinations thereof. In certain embodiments, the monocomponent fibers may have a melting point of at least 20 degrees higher than the melting point of netting 110 and may include fibers such as PET, PLA, Ziegler-Netta PP, and the like. In an exemplary embodiment, the monocomponent fibers comprise PET.

The fibers may have thicknesses that are suitable for the application. In some embodiments, the fibers have at least one dimension in the range of about 0.1 to about 10 mils or about 0.51 to about 3 mils or about 0.7 to about 2 mils. The thickness of the fibers may also be measured in denier, which is a unit of measure in the linear mass density of fibers. In some embodiments, the fibers may have a linear density of about 1 denier to about 50 denier or about 1.5 to 36 denier.

The fibers may be staple fibers or continuous fibers. The fibers may be naked (e.g., zero spin finish) or the fibers may include a spin finish. The spin finish may include but is not limited to, lubricants, emulsifiers, antistats, anti-microbial agents, cohesive agents and wetting agents. Other organic liquids, such as alcohols or blends of organic liquids may be added to the spin finish. The spin finish may be applied, for example, during carding of the fibers, during the melt spinning operation, or operation of drawing, crimping, and cutting of the fibers.

In an exemplary embodiment, the bicomponent fiber is a staple fiber having a conventional spin finish of less than about 2% and a length of about 40 to about 80 mm, or about 60 mm.

The fibers in second layer 120 may have any suitable weight, preferably between about 15 to about 250 gsm. The fibers contemplated may have many shapes in cross-section, including without limitation, circular, kidney bean, dog bone, trilobal, barbell, bowtie, star, Y-shaped, and others. These shapes and/or other conventional shapes may be used with the embodiments to obtain the desired performance characteristics.

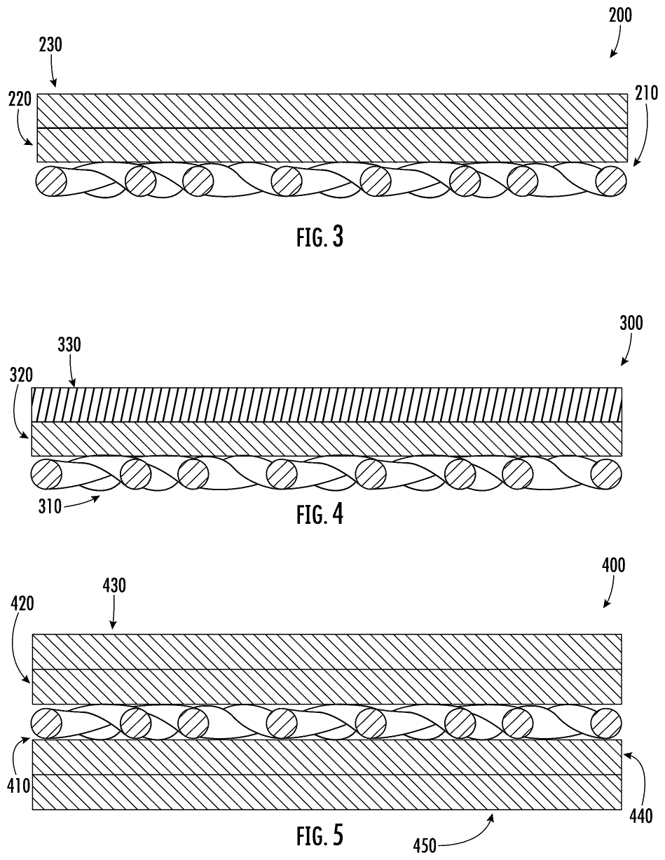

Referring now to FIG. 3, another embodiment of a composite material 200 comprises a first layer of netting 210, a second layer 220 in contact with netting 210 and a third layer 230 in contact with second layer 220. Second layer 220 is disposed between third layer 230 and netting 210. Second and third layers 220, 230 comprises fibers having a melting point that is higher than the melting point of the strands within netting 210. In various embodiments, the melting point of the fibers is at least 20 degrees Celsius higher than the melting point of the netting.

Second and third layers 220, 230 may comprise first and second fiber components. The second fiber components have a melting point within 20 degrees Celsius of the strands in the netting layer. This allows the second fiber components to thermally bond with the netting at contact points upon the application of heat and pressure. The first fiber components form an outer layer that protects netting layer 210.

In the embodiment shown in FIG. 3, the fibers second and third layers 220, 230 comprise substantially the same material. In an exemplary embodiment, the fibers in second and third layers 220, 230 comprises bicomponent fibers, such as those described above in reference to FIG. 1.

Referring now to FIG. 4, another embodiment of a composite material 300 comprises a first layer of netting 310, a second layer 320 in contact with netting 310 and a third layer 330 in contact with second layer 320. As in previous embodiments, second and third layers 320, 330 comprises a first fiber component having a melting point that is at least 20 degrees higher than the melting point of the netting and a second fiber component have a melting point within 20 degrees Celsius of the strands in the netting layer. In this embodiment, the fibers in second and third layer comprise different materials. The fibers in second layer 320 are preferably bicomponent fibers as described above. The fibers in third layer 330 may comprise bicomponent fibers with different materials than second layer (i.e., different materials for the core, the sheath or both). Alternatively, the fibers in third layer 330 comprise monocomponent fibers, such as those described above.

In one such embodiment, third layer 330 comprises fibers having a higher melting than the fibers of second layer 320 and/or netting 310 to provide thermal stability to the composite material. In an exemplary embodiment, the melting point of the fibers in third layer 330 is 30% greater than the melting point of the fibers in second layer 230 and/or the strands in netting 310.

Referring now to FIG. 5, another embodiment of a composite material 400 comprises a first layer of netting 410, a second layer 420 in contact with netting 410 and a third layer 430 in contact with second layer 420. In this embodiment, composite material 400 further comprises a fourth layer 440 in contact with netting 410 and a fifth layer 450 in contact with fourth layer 440. At least the second and fourth layers 420, 440 comprises a first fiber component having a melting point that is at least 20 degrees Celsius higher than the melting point of the netting and a second fiber component have a melting point within 20 degrees Celsius of the strands in the netting layer. In this embodiment, the second and third layers comprise substantially the same materials and the fourth and fifth layers comprise substantially the same materials. The fibers in the second and third layers may be the same, or different, from the fibers in the fourth and fifth layers.

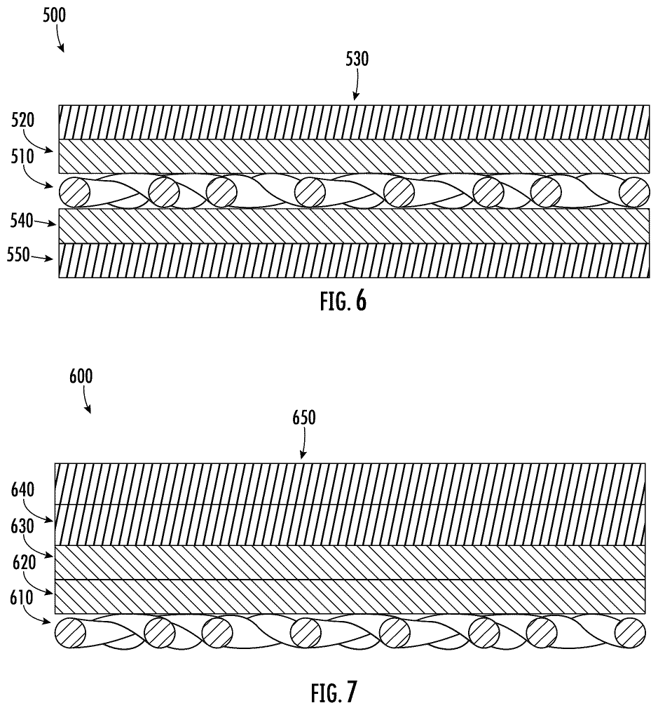

Referring now to FIG. 6, another embodiment of a composite material 500 comprises a first layer of netting 510, a second layer 520 in contact with netting 510 and a third layer 530 in contact with second layer 520. In this embodiment, composite material 500 further comprises a fourth layer 540 in contact with netting 510 and a fifth layer 550 in contact with fourth layer 440. At least the second and fourth layers 420, 440 comprises a first fiber component having a melting point that is at least 20 degrees Celsius higher than the melting point of the netting and a second fiber component have a melting point within 20 degrees Celsius of the strands in the netting layer. The second and third layers comprise different materials and the fourth and fifth layers comprise different materials. The fibers in second and fourth layers 420, 440 are preferably bicomponent fibers as described above. The fibers in third and fifth layers 430, 450 may comprise bicomponent fibers with different materials than the second and fourth layers 420, 440 (i.e., different materials for the core, the sheath or both). Alternatively, the fibers in third and fifth layers 430, 450 may comprise monocomponent fibers, such as those described above.

Referring now to FIG. 7, another embodiment of composite material 600 comprises a first layer of netting 610, a second layer 620 in contact with netting 610 and a third layer 630 in contact with second layer 620. In this embodiment, the material 600 further comprises a fourth later 640 in contact with third layer 630 and a fifth layer 650 in contact with fourth layer 640. At least the second layer 620 comprises a first fiber component having a melting point that is at least 20 degrees higher than the melting point of the netting and a second fiber component have a melting point within 20 degrees Celsius of the fibers in the netting layer. Each of the layers may comprises substantially the same material, or different materials. In some embodiments, some, but not all, of the layers comprises substantially the same material.

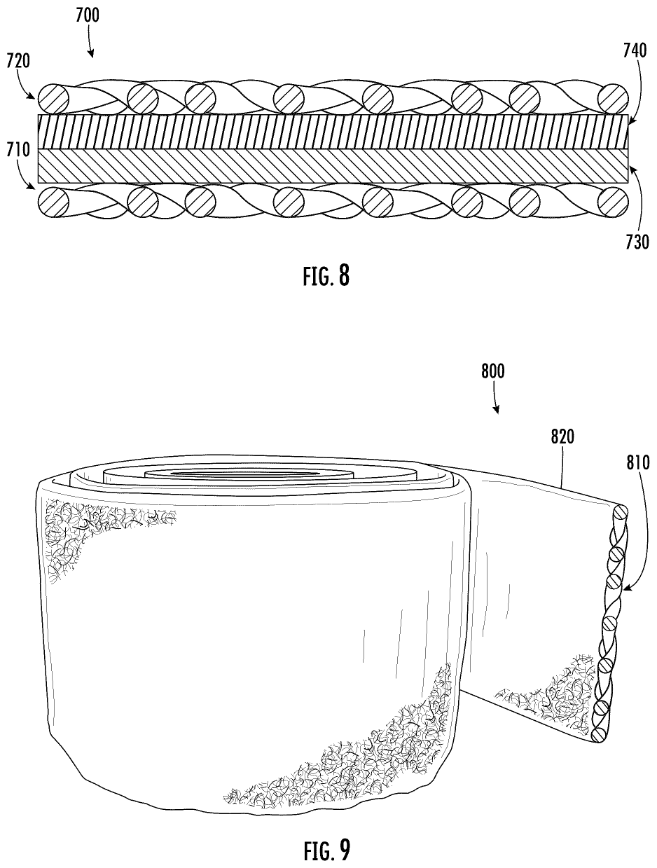

Referring now to FIG. 8, another embodiment of a composite material 700 comprises first and second layers of netting 710, 720. Material 600 further comprises a third layer 730 of fibers in contact with first netting layer 710 and a fourth layer 740 of fibers in contact with third layer 430 and second netting layer 720. In this embodiment, the netting layers 710, 720 are disposed outside of the nonwoven fiber layers 730, 740. Fiber layers 730, 740 comprises a first fiber component having a melting point that is at least 20 degrees higher than the melting point of the netting and a second fiber component have a melting point within 20 degrees Celsius of the fibers in the netting layer. Fiber layers 730, 740 may comprise substantially the same materials, or they may comprise different materials.

Referring now to FIG. 9, a filter jacket 800 comprises a netting 810 with one or more layers 820 of fibers in contact with netting 810. In this embodiment, fiber layer(s) 820 substantially surround netting 810 to form a cover or sock around the netting. Filter jacket 800 may be used for a variety of applications including, but not limited to, capillary break layers, shock pads, turf protection layers, soil consolidation, drainage, insulation, ground vibration damping, noise control and ventilation in buildings, resin infusion media, foam flow media and resin transfer media for vacuum infusion and structural injection molding, filter media for industrial filtration and waste water treatment, erosion control, soil consolidation, landfill stabilization and gas venting, reinforcement, separation, containment, protection, agricultural applications and the like

### EXAMPLES

The applicant manufactured a number of different composite materials comprising a netting with an outer layer of nonwoven biocomponent fibers in contact with the netting. The biocomponent fibers comprised a core/sheath configuration wherein the core comprised fibers having a melting point at least 20 degrees Celsius higher than the melting point of the netting and the sheath comprised fibers with a melting point within 20 degrees Celsius of the netting. In all of the below examples, the netting comprised a black HDPE diamond netting having a strand angle of 90 degrees, a strand count of 2 strands/inch, a thickness of 140 mils and a density of 500 gram/m2. The nonwoven fiber layer was bonded or laminated to the netting with a T-shirt press at 300 degrees Fahrenheit for 15 seconds.

In one example, the nonwoven fibers comprised HDPE/PET (sheath/core) bicomponent fibers that were carded and then air through bonded. The bicomponent fiber had a thickness of 20 mils and a density of 27.5 gsm. The HDPE sheath fibers bonded to the netting and the PET core fibers did not bond to the netting.

In another example, the nonwoven fibers comprised HDPE/PET (sheath/core) bicomponent fibers that were carded and then air through bonded. The bicomponent fiber had a thickness of 35 mils and a density of 35 gsm. The HDPE sheath fibers bonded to the netting and the PET core fibers did not bond to the netting.

In another example, the nonwoven fibers comprised HDPE/PET (sheath/core) bicomponent fibers that were carded and then air through bonded. The bicomponent fiber had a thickness of 70 mils and a density of 60 gsm. The HDPE sheath fibers bonded to the netting and the PET core fibers did not bond to the netting.

In another example, the nonwoven fibers comprised green HDPE/PET (sheath/core) bicomponent fibers that were carded and then air through bonded. The bicomponent fiber had a thickness of 70 mils and a density of 60 gsm. The HDPE sheath fibers bonded to the netting and the PET core fibers did not bond to the netting.

In another example, the nonwoven fibers comprises a first bicomponent HDPE/PET (sheath/core) fiber and a second monocomponent PET fiber that were blended together. The fibers were carded and then air through bonded. The blended nonwoven fiber had a thickness of 70 mils and a density of 40 gsm. The sheath fibers bonded to the netting and the core fibers did not bond to the netting. The monocomponent PET fibers also bonded to the netting.

In another example, the nonwoven fibers comprise HDPE/PET (sheath/core) green bicomponent fibers that were carded and then air through bonded. The bicomponent fibers had a thickness of 45 mils and a density of 40 gsm. The sheath fibers bonded to the netting and the core fibers did not bond to the netting.

In another example, the nonwoven fibers comprise CoPET/PET (sheath/core) bicomponent fibers that were carded and then air through bonded. The bicomponent fibers had a thickness of 45 mils and a density of 22.5 gsm. The sheath fibers bonded to the netting and the core fibers did not bond to the netting.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in a first aspect, a first embodiment is a composite material comprising netting comprising an array of intersecting strands comprising a material having a first melting point and a second layer in contact with the first layer, The second layer comprises fibers having a second melting point. The second melting point is at least about 20 degrees Celsius higher than the first melting point.

A second embodiment is the first embodiment, wherein the second layer comprises a plurality of first fiber components and a plurality of second fiber components, wherein the first fiber components have a melting point at least about 20 degrees Celsius higher than the first melting point and wherein a difference between a melting point of the second fiber components and the first melting point is less than about 20 degrees Celsius.

A third embodiment is any combination of the first two embodiments, wherein the second fiber components are thermally bonded to the first layer of netting.

A 4^{th} embodiment is any combination of the first 3 embodiments, wherein the first fiber components are not thermally bonded to the first layer of netting.

A 5^{th} embodiment is any combination of the first 4 embodiments, wherein the first and second fiber components are formed from biocomponent fibers.

A 6^{th} embodiment is any combination of the first 5 embodiments, wherein the biocomponent fibers comprise a core and a sheath, wherein the first fiber components comprise the core and the second fiber components comprise the sheath.

A 7^{th} embodiment is any combination of the first 6 embodiments, wherein the fibers in the second layer comprise nonwoven fibers.

An 8^{th} embodiment is any combination of the first 7 embodiments, further comprising a third layer comprising fibers having a third melting point, wherein the third melting point is at least about 20 degrees Celsius higher than the first melting point.

A 9^{th} embodiment is any combination of the first 8 embodiments, wherein the second layer is positioned between the first and third layers.

A 10^{th} embodiment is any combination of the first 9 embodiments, wherein the fibers of the second layer comprise a different material than the fibers of the third layer.

An 11^{th} embodiment is any combination of the first 10 embodiments, wherein the fibers of the second layer comprise the same material as the fibers of the third layer.

A 12^{th} embodiment is any combination of the first 11 embodiments, further comprising a fourth layer of netting comprising fibers having a fourth melting point, wherein the second and third melting points are higher than the fourth melting point.

A 13^{th} embodiment is any combination of the first 12 embodiments, wherein the second and third layers are positioned between the first and fourth layers.

A 14^{th} embodiment is any combination of the first 13 embodiments, further comprising fourth and fifth layers of fibers each having a melting point higher than the first melting point.

A 15^{th} embodiment is any combination of the first 14 embodiments, wherein the second and third layers are positioned on a first surface of the first layer and the fourth and fifth layers are positioned on a second surface of the first layer opposite the first surface.

A 16^{th} embodiment is any combination of the first 15 embodiments, wherein the second and third layers are disposed between the first layer and the fourth and fifth layers.

A 17^{th} embodiment is any combination of the first 16 embodiments, wherein the first layer of netting comprises a material selected from the group consisting of high density polyethylene (HDPE), polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof.

An 18^{th} embodiment is any combination of the first 17 embodiments, wherein the first layer of netting comprises HDPE, PP and combinations thereof.

A 19^{th} embodiment is any combination of the first 18 embodiments, wherein the fibers in the second layer comprise a material selected from the group consisting of PET, PLA, Ziegler-Netta PP and combinations thereof.

A 20^{th} embodiment is any combination of the first 19 embodiments, wherein the first fibers in the second layer comprise a material selected from the group consisting of PET, PLA, Ziegler-Netta PP and combinations thereof and the second fibers in the second layer comprise a material selected from the group consisting of HDPE, metallocene PP, CoPET, PP, PLA and combinations thereof.

A 21^{st} embodiment is any combination of the first 20 embodiments, wherein the first fibers in the second layer comprise PET and the second fibers in the second layer comprise HDPE.

In another aspect, a resin infusion media is provided comprising the composite material of any of the above 21 embodiments.

In another aspect, an acoustic insulation material is provided comprising the composite material of any of the above 21 embodiments.

In another aspect, a drainage mat is provided comprising the composite material of any of the above 21 embodiments.

In another aspect, a capillary break layer is provided comprising the composite material of any of the above 21 embodiments.

In another aspect, an erosion control device is provided comprising the composite material of any of the above 21 embodiments.

In another aspect, a ground vibration dampener is provided comprising the composite material of any of the above 21 embodiments.

In another aspect, a landfill stabilization device is provided comprising the composite material of any of the above 21 embodiments.

In another aspect, a filter media is provided comprising the composite material of any of the above 21 embodiments.

In another aspect, a gas venting device is provided comprising the composite material of any of the above 21 embodiments.

In another aspect, a soil protection layer is provided comprising the composite material of any of the above 21 embodiments.

In another aspect, a first embodiment is a composite material comprising a layer of netting having a first melting point and a plurality of first fibers in contact with the layer of netting and having a second melting point. The second melting point is at least about 20 degrees higher than the first melting point. The composite material further comprises a plurality of second fibers in contact with the layer of netting and having a third melting point. The difference between the first and third melting points is less than about 20 degrees Celsius

A second embodiment is the first embodiment, wherein the second fibers are thermally bonded to the netting.

A 3^{rd} embodiment is any combination of the first 2 embodiments, wherein the first and second fibers are formed from biocomponent fibers.

A 4^{th} embodiment is any combination of the first 3 embodiments, wherein the biocomponent fibers comprise a core and a sheath, wherein the first fibers comprise the core and the second fibers comprise the sheath.

A 5^{th} embodiment is any combination of the first 4 embodiments, wherein the first and second fibers comprise nonwoven fibers.

A 6^{th} embodiment is any combination of the first 5 embodiments, wherein the netting comprises a material selected from the group consisting of high density polyethylene (HDPE), polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof.

A 7^{th} embodiment is any combination of the first 6 embodiments, wherein the netting comprises HDPE.

An 8^{th} embodiment is any combination of the first 7 embodiments, wherein the first fibers comprise a material selected from the group consisting of PET, PLA, Ziegler-Netta PP and combinations thereof.

A 9^{th} embodiment is any combination of the first 8 embodiments, wherein the second fibers comprise a material selected from the group consisting of HDPE, metallocene PP, CoPET, PP, PLA and combinations thereof.

A 10^{th} embodiment is any combination of the first 9 embodiments, wherein the first fibers comprise PET and the second fibers comprise HDPE.

In another aspect, a resin infusion media is provided comprising the composite material of any of the above 10 embodiments.

In another aspect, an acoustic insulation material is provided comprising the composite material of any of the above 10 embodiments.

In another aspect, a drainage mat is provided comprising the composite material of any of the above 10 embodiments.

In another aspect, a capillary break layer is provided comprising the composite material of any of the above 10 embodiments.

In another aspect, an erosion control device is provided comprising the composite material of any of the above 10 embodiments.

In another aspect, a ground vibration dampener is provided comprising the composite material of any of the above 10 embodiments.

In another aspect, a landfill stabilization device is provided comprising the composite material of any of the above 10 embodiments.

In another aspect, a filter media is provided comprising the composite material of any of the above 10 embodiments.

In another aspect, a gas venting device is provided comprising the composite material of any of the above 10 embodiments.

In another aspect, a soil protection layer is provided comprising the composite material of any of the above 10 embodiments.

In another aspect, a method of manufacturing a composite material comprises providing a netting and first and second fibers having first and second melting points, and heating the first and second fibers and the netting to a temperature at or above the second melting point and below the first melting point to thermally bond the second fibers to the netting.

A second embodiment is the first embodiment, wherein the netting has a third melting point at least 20 degrees less than the first melting point.

A third embodiment is any combination of the first 2 embodiments, wherein the second melting point is substantially equal to the third melting point.

A 4^{th} embodiment is any combination of the first 3 embodiments, wherein the netting and the second fibers are thermally bonded by lamination, calendaring, air through bonding, ultrasonic bonding or chemical bonding.

A 5^{th} embodiment is any combination of the first 4 embodiments, further comprising laminating and calendaring the netting and the first and second fibers.

A 6^{th} embodiment is any combination of the first 5 embodiments, further comprising forming bicomponent fibers comprising the first and second fibers.

A 7^{th} embodiment is any combination of the first 6 embodiments, wherein the first fibers are a core of the bicomponent fibers and the second fibers are a sheath of the bicomponent fibers.

An 8^{th} embodiment is any combination of the first 7 embodiments, wherein the bicomponent fibers are carded.

A 9^{th} embodiment is any combination of the first 8 embodiments, wherein the biocomponent fibers are air through bonded.

In another aspect, a resin infusion media is manufactured from the method of any of the above 9 embodiments.

1. A composite material comprising:
a first layer of netting comprising an array of intersecting strands comprising a material having a first melting point; and
a second layer in contact with the first layer, the second layer comprising fibers having a second melting point, wherein the second melting point is at least about 20 degrees Celsius higher than the first melting point.

2. The composite material of claim 1, wherein the second layer comprises first and second fiber components wherein the first fiber components have a melting point at least about 20 degrees Celsius higher than the first melting point and wherein a difference between a melting point of the second fiber components and the first melting point is less than about 20 degrees Celsius.

3. The composite material of claim 2, wherein the second fiber components are thermally bonded to the first layer.

4. The composite material of claim 2, wherein the first and second fiber components are formed from biocomponent fibers.

5. The composite material of claim 4, wherein the biocomponent fibers comprise a core and a sheath, wherein the first fiber components comprise the core and the second fiber components comprise the sheath.

6. The composite material of claim 1, further comprising a third layer comprising fibers having a third melting point, wherein the third melting point is at least about 20 degrees Celsius higher than the first melting point.

7. The composite material of claim 6, wherein the second layer is positioned between the first and third layers.

8. The composite material of claim 7, further comprising a fourth layer of netting comprising fibers having a fourth melting point, wherein the second and third melting points are higher than the fourth melting point.

9. The composite material of claim 8, wherein the second and third layers are positioned between the first and fourth layers.

10. The composite material of claim 1, wherein the first layer of netting comprises a material selected from the group consisting of high density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof.

11. The composite material of claim 1, wherein the first layer of netting comprises HDPE, PP and combinations thereof.

12. The composite material of claim 1, wherein the fibers in the second layer comprise a material selected from the group consisting of PET, PLA, Ziegler-Netta PP and combinations thereof.

13. The composite material of claim 2, wherein the first fiber components in the second layer comprise a material selected from the group consisting of PET, PLA, Ziegler-Netta PP and combinations thereof and the second fiber components in the second layer comprise a material selected from the group consisting of HDPE, metallocene PP, CoPET, PP, PLA and combinations thereof.

14. The composite material of claim 2, wherein the first fiber components in the second layer comprise PET and the second fiber components in the second layer comprise HDPE.

15. A resin infusion media comprising the composite material of claim 1.

16. A composite material comprising:
a layer of netting comprising an array of intersecting strands having a first melting point;
a plurality of first fibers in contact with the layer of netting and having a second melting point, wherein the second melting point is at least about 20 degrees higher than the first melting point; and
a plurality of second fibers in contact with the layer of netting and having a third melting point, wherein a difference between the first and third melting points is less than about 20 degrees Celsius.

17. The composite material of claim 16, wherein the second fibers are thermally bonded to the netting.

18. The composite material of claim 16, wherein the first and second fibers are formed from biocomponent fibers.

19. The composite material of claim 18, wherein the biocomponent fibers comprise a core and a sheath, wherein the first fibers comprise the core and the second fibers comprise the sheath.

20. The composite material of claim 16, wherein the netting comprises a material selected from the group consisting of high density polyethylene (HDPE), polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF) and combinations thereof.

21. The composite material of claim 16, wherein the first fibers comprise a material selected from the group consisting of PET, PLA, Ziegler-Netta PP and combinations thereof.

22. The composite material of claim 21, wherein the second fibers comprise a material selected from the group consisting of HDPE, metallocene PP, CoPET, PP, PLA and combinations thereof.
